(19) United States
(12) Patent Application Publication
(10) Pub. No.: US 2004/0076862 A1
(43) Pub. Date: Apr. 22, 2004

(54) Fuel cell system

(76) Inventors: Rolf Bruck, Bergisch Gladbach (DE); Joachim Grosse, Erlangen (DE); Manfred Poppinger, Uttenreuth (DE); Meike Reizig, Bad Munstereifel (DE)

Correspondence Address: LERNER AND GREENBERG, P.A., Post Office Box 2480, Hollywood, FL, 33022-2480, US

(21) Appl. No.: 10/610,188

(22) Filed: Jun. 30, 2003

Related U.S. Application Data
(63) Continuation of application No. PCT/DE01/04886, filed on Dec. 21, 2001.

(30) Foreign Application Priority Data
Dec. 29, 2000 (DE) 100 65 308.1

(51) Int. Cl. H01M 8/04; H01M 8/10

(52) U.S. Cl. 429/26; 429/38; 429/32

(57) ABSTRACT

A fuel cell stack has a heating device for preheating the feed air with a heat exchanger. The heat exchanger, at least in one dimension of the flat area arrangement, has the same size as the fuel cell stack. This makes it possible for heat exchanger and fuel cell stack to be arranged one behind the other in a simple way and advantageously enables them to be accommodated in a common housing.

### CROSS-REFERENCE TO RELATED APPLICATION

This application is a continuation of copending International Application No. PCT/DE01/04886, filed Dec. 21, 2001, which designated the United States and which was not published in English.

### BACKGROUND OF THE INVENTION

### FIELD OF THE INVENTION

The invention lies in the fuel cell technology field. More specifically, the invention relates to a fuel cell system having at least one fuel cell stack of individual fuel cells and air supply channels between the fuel cells, as well as a heater, including a heat exchanger, for preheating the feed air.

Numerous forms of fuel cell facilities for supplying energy to electric motor drives for motor vehicles are known. A common feature of these different fuel cell systems is the chemical reaction between hydrogen and oxygen to form water. However, gaseous hydrogen cannot be stored on board in a quantity which is sufficient for prolonged driving operation.

For example, the PEM fuel cell (polymer electrolyte membrane, proton exchange membrane), which operates with a proton-conducting membrane, uses gasoline, methanol or another higher hydrocarbon from which hydrogen-rich gas is obtained as fuel gas by means of a reformer and with oxygen from ambient air. In particular the HT-PEM fuel cell, which operates at relatively high temperatures, is per se insensitive to impurities, which is true in particular of the fuel gas. The oxidizing agent is obtained from ambient air; in principle, the starting point is normal ambient air which, for example, can be taken from the slip stream of a moving vehicle. The ambient air is generally at a significantly lower temperature than the fuel cell. When the cold air is fed into the fuel cell, the fuel cell may be damaged in particular at the air inlet.

Therefore, a heat exchanger, which in particular provides the thermal energy for preheating the feed air, is crucial for operation of a fuel cell system of this type in a motor vehicle.

U.S. Pat. No. 6,106,964 discloses a method of humidifying and adjusting the temperature of a process gas stream in a solid polymer fuel cell. There, a heat exchanger formed of two plates is disposed in immediate heat-transfer contact with a fuel cell stack. Japanese patent application JP 09-204924 discloses a fuel cell stack of individual coated fuel cells. Each individual fuel cell unit is thereby connected to a coolant line via a cooler plate. The cooler plate thereby has the same dimensioning as an individual fuel cell unit.

The placement and dimensioning of the heat exchangers in the prior art are not yet optimized with regard to ease of manufacture and efficiency in operation.

### SUMMARY OF THE INVENTION

It is accordingly an object of the invention to provide a fuel cell system which overcomes the above-mentioned disadvantages of the heretofore-known devices and methods of this general type and which is provided with a heat exchanger and in which the complex heat exchanger is assigned to the fuel cell stack in a suitable way.

With the foregoing and other objects in view there is provided, in accordance with the invention, a fuel cell system comprising:

at least one fuel cell stack formed of individual fuel cells and air supply channels between the fuel cells for supplying feed air to the fuel cells, the fuel cell stack having an edge and given dimensions;

a heating device for preheating the feed air, the heating device including a heat exchanger having at least one common edge in common with the edge of the fuel cell stack and, at least in one dimension, having the same size as the fuel cell stack, the heat exchanger being formed of a stack of individual heat exchanger plates defining heat exchanger channels communicating with the air supply channels of the fuel cell stack via the common edge.

This implementation assures optimal air supply to the stack.

The heat exchanger may be a separate component connected upstream (in the air flow direction) of the fuel cell stack. Alternatively, the heat exchanger may be arranged vertically above the fuel cell stack, in which case an aligned arrangement is produced on account of the identical transverse dimensions.

In the invention, it is particularly advantageous that the heat exchanger passages and the air-feed passages of an individual fuel cell can be directly connected to one another. In alternative possible arrangements, the heat exchanger and the fuel cell stack are advantageously accommodated in a common housing. The heat exchanger is of particular importance in particular in the latter case.

In accordance with an additional feature of the invention, the heat exchanger and the fuel cell stack are functionally connected in series.

In accordance with another feature of the invention, the heat exchanger passages of the heat exchanger and the air supply channels of the fuel cells of the fuel cell stack have identical dimensions and an equal flow cross section.

In accordance with a preferred embodiment of the invention, the heat exchanger and the fuel cell stack are disposed inside a common housing. This provides for an advantageously compact and robust system.

In accordance with a further feature of the invention, the heat exchanger is connected up to the fuel cell stack together with an evaporator and/or a condenser.

In accordance with again an added feature of the invention, the heat exchanger is electrically heated. In the alternative, or in addition, the heat exchanger includes a latent heat store.

In accordance with again an additional feature of the invention, the heat exchanger is configured as a mixer for rectifying the flow of air.

In accordance with again a further feature of the invention, the fuel cells are cooled with a cooling medium that is also used as the heat transfer medium for the heat exchanger.

In accordance with a concomitant feature and preferable implementation of the invention, the fuel cell stack includes PEM fuel cells. In a preferred embodiment, the fuel cell stack includes HT-PEM (high temperature polymer electrolyte membrane) fuel cells.

Other features which are considered as characteristic for the invention are set forth in the appended claims.

Although the invention is illustrated and described herein as embodied in a fuel cell system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic perspective illustration of a fuel cell stack with a heat exchanger aligned in front of it; and

FIG. 2 is a partly broken-away, perspective illustration of an alternative configuration compared to FIG. 1, in which the heat exchanger is disposed in alignment vertically above the fuel cell stack.

### DESCRIPTION OF THE PREFERRED EMBODIMENTS

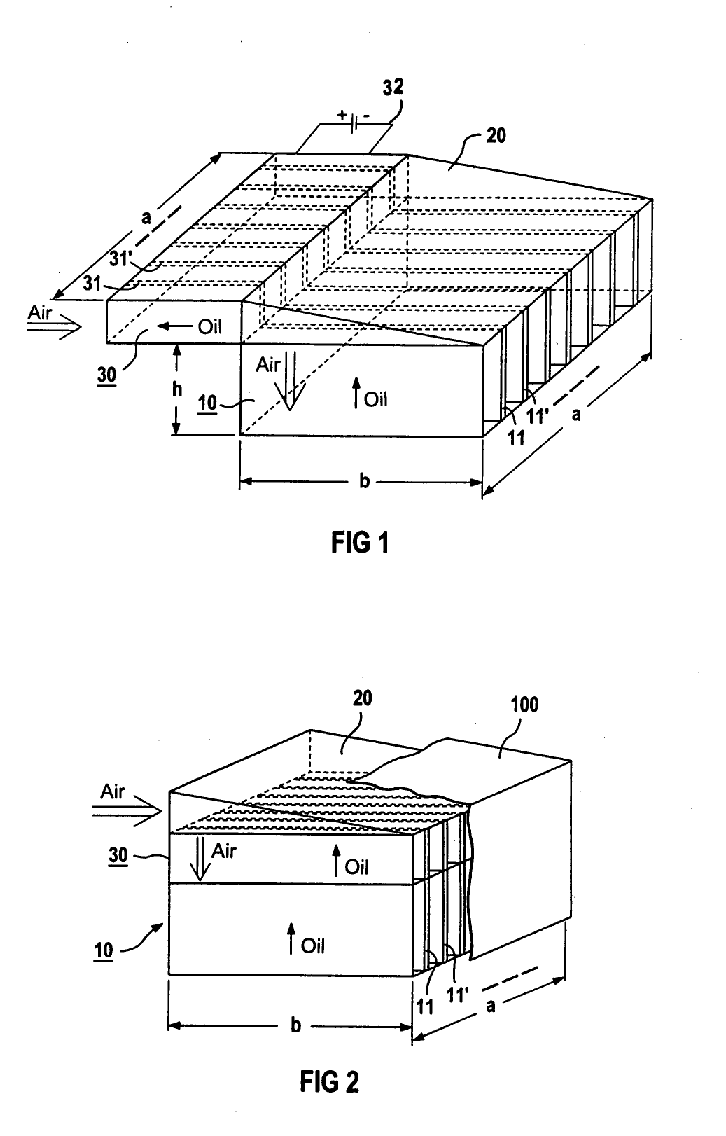

Referring now to the figures of the drawing in detail and first, particularly, to FIG. 1 thereof, there is shown a fuel cell system, the basic parts of which have been extensively described in other contexts. A module 10 of the fuel cell system is generally also referred to as a stack. A stack comprises a stacked arrangement of individual fuel cells 11, 11′, . . . of width b and height h. An overall stack width a is formed by the fuel cell stack 10. In this case, the individual fuel cells are stacked in such a manner that there is in each case a space between two cells, through which air is passed in order to supply the cells. The individual spaces may be configured in the form of passages.

Fuel cells which operate with a solid electrolyte and are described as PEM (polymer electrolyte membrane or proton exchange membrane) fuel cells are used for the fuel cell system. Fuel cells of this type are known from the prior art, and for mobile applications fuel cells of this type are advantageously operated at higher temperatures than have previously been described. Operating temperatures of between 80° C. and 300° C., in particular in the range from 120° C. to 200° C., are used for HT (high temperature) PEM fuel cells of this type. For practical operation, advantages are in particular the lack of influence of the humidity of the process gases, on the one hand, and the moisture of the membrane, on the other hand. The membrane used in this case is made from temperature-stable materials which hold a self-dissociating and/or autoprotolytic electrolyte. Furthermore, reduced demands are imposed on the purity of the process gas.

In particular, CO impurity levels of up to approximately 10,000 ppm are tolerated.

To maintain the optimum operating temperature, the fuel cell module is cooled. Cooling is effected, for example, using a liquid medium, such as for example, a suitable oil. The coolant fluid is fed to a heat exchanger 30, where it heats the feed air.

The heat exchanger 30 is configured as a plate-type heat exchanger with individual plates 31, 31′, . . . . The plates 31, 31′, . . . are arranged at a distance from one another, so that a space is formed through which the air is guided. The fluid of the heat exchanger 30 is guided in the plates 31, 31′, . . . . The space between the plates 31, 31′. . . can in turn be configured in the form of passages.

In both FIGS. 1 and 2, the heat exchanger 30 described is in each case connected upstream of the fuel cell module 10. The way in which the fluid is guided is indicated with the labeled arrows. If the heat exchanger 30 has the same dimension a as the stack width of the fuel cell module 10 perpendicular to the surface of the individual cells 11, 11′, . . . , then the heat exchanger 30 can be assigned to the fuel cell module 10 in such a manner that it is aligned therewith in at least one dimension, as shown in FIG. 1.

In accordance with FIG. 1, the plates 31, 31′, . . . of the heat exchanger 30 are aligned with respect to the cells 11, 11, . . . of the fuel cell module 10. The cooling air is supplied from the front side and, after it has flowed through the heat exchanger 30, it is diverted onto the fuel cell stack 10 by means of a suitably arranged plate 20. Therefore, in particular in the case of a self-aspirating fuel cell system, the air which has been preheated after it has flowed through the heat exchanger 30 can be fed to the individual fuel cells 11, 11′ over their area.

However, as shown in FIG. 2, it is also possible for the heat exchanger 30 to be arranged above the fuel cell module 11, 11′, . . . . This is expedient if cell cooling and heat exchanger function are to be integrated in a single component. The air which flows in at the front is in this case diverted prior to its flowing into the assembly. Here, the cooling medium successively flows through the heat exchanger 20 and the fuel cell stack 10 in the same direction. Consequently, the cooling medium of the fuel cells 11, 11′, . . . therefore serves as a heat transfer medium for the heat exchanger 30. The fuel cell module 10 and the heat exchanger 30 are advantageously arranged in a common housing 100.

In both configurations, corresponding to FIG. 1 or FIG. 2, it is advantageous if the spaces or passages formed by the heat exchanger plates 31, 31′ . . . of the heat exchanger 30 and the spaces or passages formed by the fuel cells 11, 11′, . . . adjoin one another seamlessly. This makes the system easy to assemble.

In further exemplary embodiments which supplement or modify FIG. 1 or 2, the heat exchanger 30 may be assigned to the fuel cell stack 10 together with an evaporator and/or a condenser. The heat exchanger 30 may be electrically heated, for example with a resistance heating system, as diagrammatically indicated at 32. Furthermore, the heat exchanger 30 may be assigned a latent heat store. In this case, the heat exchanger serves as a mixer for rectifying the flow of the incoming air.

It has been found that the configurations described operate particularly advantageously in combination with PEM fuel cells. In particular if fuel cells of this type are operated at elevated temperatures, i.e. the individual fuel cell works as what is known as an HT-PEM fuel cell, the heat exchanger having the properties described is highly advantageous for disruption-free operation of the system as a whole.

We claim:

1. A fuel cell system comprising:
at least one fuel cell stack formed of individual fuel cells and air supply channels between said fuel cells for supplying feed air to said fuel cells, said fuel cell stack having an edge and given dimensions;
a heating device for preheating the feed air, said heating device including a heat exchanger having at least one common edge in common with said edge of said fuel cell stack and, at least in one dimension, having the same size as said fuel cell stack, said heat exchanger being formed of a stack of individual heat exchanger plates defining heat exchanger channels communicating with said air supply channels of said fuel cell stack via said common edge.

2. The fuel cell system according to claim 1, wherein said heat exchanger and said fuel cell stack have at least one identical cross-sectional area.

3. The fuel cell system according to claim 1, wherein said heat exchanger and said fuel cell stack are functionally connected in series.

4. The fuel cell system according to claim 1, wherein said heat exchanger passages of said heat exchanger and said air supply channels of said fuel cells of said fuel cell stack have identical dimensions and an equal flow cross section.

5. The fuel cell system according to claim 1, which comprises a common housing enclosing said heat exchanger and said fuel cell stack.

6. The fuel cell system according to claim 1, wherein said heat exchanger is connected up to said fuel cell stack together with at least one of an evaporator and a condenser.

7. The fuel cell system according to claim 1, wherein said heat exchanger is an electrically heated heat exchanger.

8. The fuel cell system according to claim 1, wherein said heat exchanger includes a latent heat store.

9. The fuel cell system according to claim 1, wherein said heat exchanger is configured as a mixer for rectifying the flow of air.

10. The fuel cell system according to claim 1, wherein said fuel cells are cooled with a cooling medium also forming a heat transfer medium for said heat exchanger.

11. The fuel cell system according to claim 1, wherein said fuel cell stack includes PEM fuel cells.

12. The fuel cell system according to claim 1, wherein said fuel cell stack includes high temperature-PEM fuel cells.
